(19) United States
(12) Patent Application Publication
(10) Pub. No.: US 2013/0028431 A1
(43) Pub. Date: Jan. 31, 2013

(54) MULTIFUNCTIONAL ELECTRONIC ACCESSORY

(71) Applicants: WEN-DONG LUO, Shenzhen (CN); WEN-WU WANG, Shenzhen (CN); BIN LIU, Shenzhen (CN); TSUNG-JEN CHUANG, Tu-Cheng (TW); SHIH-FANG WONG, Tu-Cheng (TW)

(72) Inventors: WEN-DONG LUO, Shenzhen (CN); WEN-WU WANG, Shenzhen (CN); BIN LIU, Shenzhen (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/310,710

(22) Filed: Dec. 3, 2011

(30) Foreign Application Priority Data
Jul. 29, 2011 (CN) 201110215558.8

(51) Int. Cl. H04B 3/20

(52) U.S. Cl. 381/66

(57) ABSTRACT

An electronic accessory for an electronic device includes an audio processing circuit. The audio processing circuit includes a first switch circuit, an echo cancellation circuit and an amplification circuit. The echo cancellation circuit removes echoes from a first voice signal from a user in a call and a second voice signal from a caller, outputs the first voice signal to the electronic device via the first switch circuit, and outputs the second voice signal to the amplification circuit. The amplification circuit amplifies the second voice signal. The amplification circuit further directly receives and amplifies a third voice signal from multimedia content stored in the electronic device via the first switch circuit.

### BACKGROUND

1. Technical Field

The present disclosure relates to a multifunctional electronic accessory capable of assisting electronic devices in performing a plurality of functions.

2. Description of Related Art

An electronic device, such as a smart phone, or a tablet computer is used in daily life. When the electronic device is used as a telephone and as a hands-free device when a user is driving a car, the user may have difficulty listening to a caller because of outside noise. Accordingly, an electronic accessory, such as an earphone, is needed. However, it is uncomfortable for the user to wear the earphone in the ear for a long time.

Furthermore, when the electronic device utilizes a global positioning system (GPS) receiver of the electronic device, a carrier of the electronic device may charge the user an additional fee.

What is needed, therefore is a multifunctional electronic accessory that can overcome the aforementioned problems.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the various views.

FIG. 1 is a block diagram of one embodiment of a multifunctional electronic accessory including a signal processing unit, a power processing circuit, an indication circuit and an audio processing circuit.

FIG. 2 is a block diagram of one embodiment of the signal processing unit of FIG. 1.

FIG. 3 is a circuit diagram of one embodiment of the indication circuit of FIG. 1.

FIG. 4 is a block diagram of one embodiment of the power processing circuit of FIG. 1.

FIG. 5 is a block diagram of one embodiment of the audio processing circuit of FIG. 1.

### DETAILED DESCRIPTION

Reference will be made to the drawings to describe specific exemplary embodiments of the present disclosure in detail.

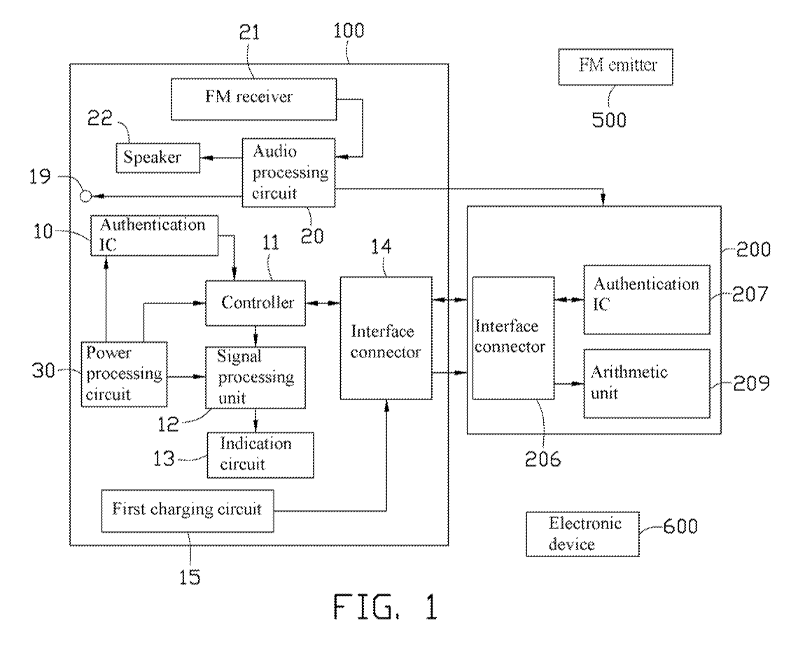

FIG. 1 is a block diagram of one embodiment of a multifunctional electronic accessory 100. The electronic accessory 100 is capable of assisting an electronic device 200 in performing a plurality of functions. The electronic device 200 may, for example, be a smart phone or a tablet computer, for example.

The electronic accessory 100 includes an authentication integrated circuit (IC) 10, a controller 11, a signal processing unit 12, an indication circuit 13, an interface connector 14, a first charging circuit 15, a power processing circuit 30, an audio processing circuit 20, a frequency modulation (FM) receiver 21, a speaker 22, and a speaker port 19. The first charging circuit 15 is connected to the interface connector 14. The power processing circuit 30 is connected to the authentication IC 10, the controller 11, and the signal processing unit 12. The controller 11 is further connected to the authentication IC 10, the interface connector 14, and the signal processing unit 12. The signal processing unit 12 is further connected to the indication circuit 13. The FM receiver 21 is connected to the speaker 22 via the audio processing circuit 20, and is further connected to the speaker port 19 via the audio processing circuit 20. The interface connector 14 may, for example, be a universal asynchronous receiver/transmitter (UART).

Authentication information about the electronic device 200 is stored in the authentication IC 10. The authentication IC 10 identifies whether the electronic accessory 100 matches (e.g., can be paired with) the electronic device 200 according to the authentication information. The authentication information may, for example, be password(s), electrical compatibility, or protocol compatibility.

The controller 11 controls data transfers and exchanges between the electronic accessory 100 and the electronic device 200.

The signal processing unit 12 receives satellite signals, and decodes the received satellite signals to provide the decoded satellite signals to the electronic device 200 to enable positional and navigational functions of the electronic device 200.

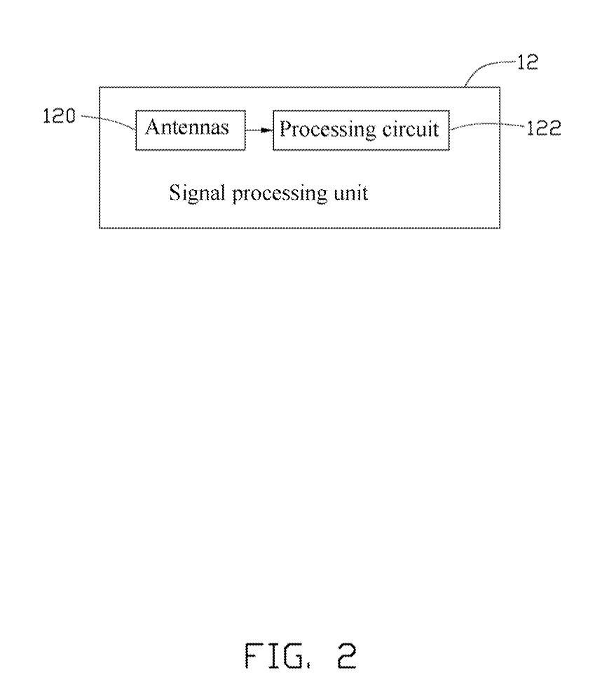

FIG. 2 is a block diagram of one embodiment of the signal processing unit 12. The signal processing unit 12 includes antennas 120 and a processing circuit 122. The antennas 120 are configured for receiving the satellite signals, and providing the satellite signals to the processing circuit 122. The processing circuit 122 is configured for decoding the satellite signals to assist operation of the positional and navigational functions.

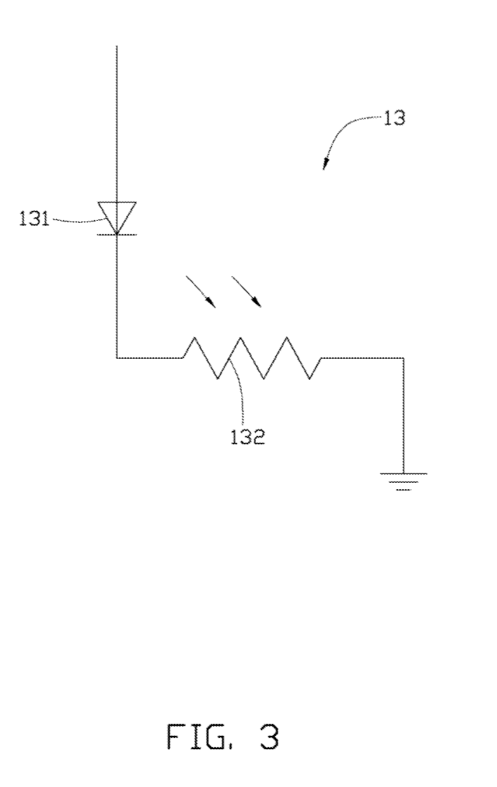

The indication circuit 13 emits light according to different working states of the signal processing unit 12. Referring to FIG. 3, FIG. 3 is a circuit diagram of one embodiment of the indication circuit 13. The indication circuit 13 may include a light emitting diode (LED) 131 and a resistor 132. The LED 131 and the resistor 132 are connected in series between the signal processing unit 12 and ground. The LED 131 is exposed at a visible surface of the electronic accessory 100, and is configured for emitting light according to the different working states of the signal processing unit 12. The emitted light may vary in color or pulses, for example. The resistor 132 is configured for limiting electrical current flowing through the LED 131.

The first charging circuit 15 receives power from an external power supply (not shown), and converts the power into a desired charging current, so as to charge or recharge a battery of the electronic device 200. The supply current may, for example, be 1.2 amps (1.2 A), the charging current may, for example, be 1 A.

The power processing circuit 30 receives power from the external power supply, and stores and provides the power to the controller 11, the authentication IC 10 and the signal processing unit 12.

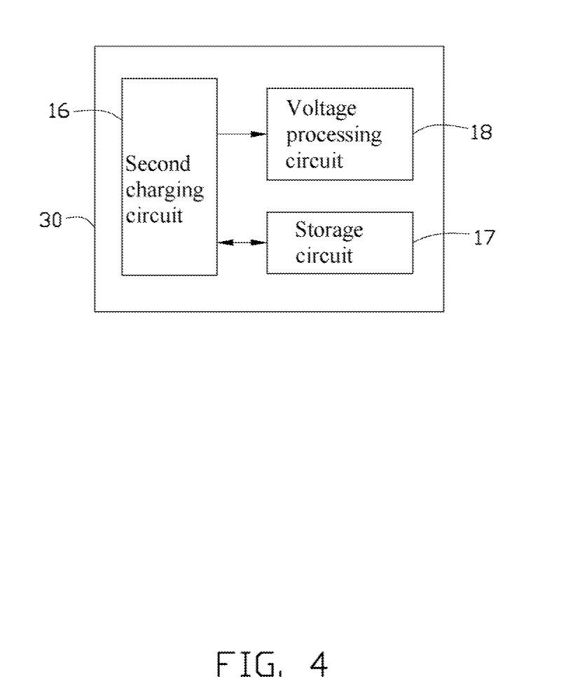

FIG. 4 is a block diagram of one embodiment of the power processing circuit 30. The power processing circuit 30 includes a second charging circuit 16, a storage circuit 17, and a voltage processing circuit 18. The storage circuit 17 is connected to the second charging circuit 16. The second charging circuit 16 is connected to the controller 11 via the voltage processing circuit 18, to the signal processing unit 12 via the voltage processing circuit 18, and is further connected to the authentication IC 10 via the voltage processing circuit 18.

The second charging circuit 16 receives power from the external power supply, and charges the storage circuit 17. In addition, the second charging circuit 16 converts the voltage of the power into a desired voltage, and outputs the converted voltage to the voltage processing circuit 18. The voltage of the power supplied may, for example, be 5V. The converted voltage may, for example, be a voltage between 3.4V and 4.2V.

The storage circuit 17 stores the power from the external power supply via the second charging circuit 16, and supplies the stored power to the voltage processing circuit 18 via the second charging circuit 16 in the absence of an external power supply to provide power for the electronic accessory 100. The storage circuit 17 may be, for example, a battery.

The voltage processing circuit 18 receives the converted voltage from the second charging circuit 16, and regulates the converted voltage to provide a steady working voltage to the authentication IC 10, the controller 11 and the signal processing unit 12.

The FM receiver 21 receives a digital wireless audio signal emitted by an external FM emitter 500 at a certain frequency, converts the received digital signal into an analog signal, and further outputs the analog signal to the audio processing circuit 20. User input of the certain frequency may be achieved by pressing a certain key on the electronic accessory 100.

The audio processing circuit 20 may process audio signals generated in different ways. For instance, when the electronic device 200 acts as a telephone and communicates with other electronic devices, such as another electronic device 600, the audio processing circuit 20 receives and processes a first voice signal from a user of the electronic device 200, and a second voice signal from the person using the electronic device 600. When the electronic device 200 plays multimedia files, the audio processing circuit 20 receives and processes a third audio signal from the multimedia content, such as the audio signals in music, or in a video file, for example. When the FM receiver 21 outputs an analog signal, the audio processing circuit 20 receives and processes the analog signal. The analog signal is defined as a fourth voice signal.

In detail, when the electronic accessory 100 assists the electronic device 200 in functioning as a telephone, the audio processing circuit 20 receives the first voice signal, removes (e.g., cancels, reduce) echoes from the first voice signal, and outputs the first voice signal having a reduced number of echoes to the electronic device 200. Further, in receiving the second voice signal, the audio processing circuit 20 removes echoes from the second voice signal, and then amplifies the second voice signal. Then the audio processing circuit 20 outputs the amplified second voice signal via a loudspeaker, for example, or other electro-acoustic conversion component. In detail, the audio processing circuit 20 removes echoes which may involves first recognizing the originally transmitted signal that re-appears, with some delay, in the first or second signal.

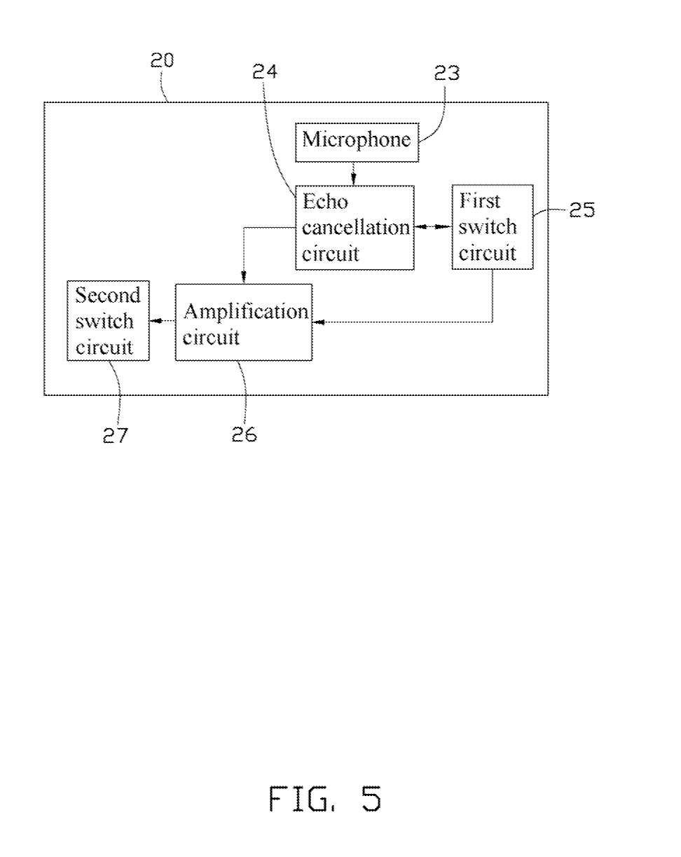

Once the echoes are recognized, they can be removed by subtracting them from the first or second signal. This technique is generally implemented using a digital signal processor (DSP), but can also be implemented in software. Echo cancellation is done using either echo suppressors or an echo cancellation circuit 24 (shown in FIG. 5), or in some cases both.

When the electronic accessory 100 assists the electronic device 200 in playing multimedia files, the audio processing circuit 20 receives the third voice signal, amplifies the third voice signal, and outputs the amplified third voice signal via the electro-acoustic component.

When the electronic accessory 100 acts as a radio receiver, the audio processing circuit 20 receives the fourth voice signal, amplifies the fourth voice signal, and outputs the amplified fourth voice signal via the electro-acoustic component.

The electro-acoustic conversion component may be the speaker 22 inside the electronic accessory 100, or an external speaker (not shown) detachably connected to the speaker port 19. If the speaker port 19 is connected to the external speaker, the audio processing circuit 20 outputs the second, third and fourth voice signals to the external speaker via the speaker port 19 after amplification. If there is no such connection, the audio processing circuit 20 outputs the amplified second, third and fourth voice signals to the speaker 22.

FIG. 5 is a block diagram of one embodiment of the audio processing circuit 20 including a microphone 23, the echo cancellation circuit 24, a first switch circuit 25, an amplification circuit 26, and a second switch circuit 27. The microphone 23 is connected to the amplification circuit 26 and the first switch circuit 25 via the echo cancellation circuit 24. The first switch circuit 25 is further connected to the amplification circuit 26 and the FM receiver 21. The amplification circuit 26 is further connected to the speaker 22 and the speaker port 19.

When the electronic device 200 acts as a telephone, the microphone 23 receives the first voice signal, converts the first voice signal from an acoustical signal into an electrical signal, and outputs the converted first voice signal to the echo cancellation circuit 24. The echo cancellation circuit 24 receives the converted signal, removes the echoes from the converted signal, and outputs the first voice signal having a reduced number of echoes to the first switch circuit 25. The first switch circuit 25 receives the first voice signal without echoes, and outputs the echo-free first voice signal to the electronic device 200. In addition, the first switch circuit 25 transmits the second voice signal outputted by the electronic device 200 to the echo cancellation circuit 24. The echo cancellation circuit 24 receives the second voice signal, removes the echoes from the second voice signal as in the case of the first voice signal, and outputs the second voice signal having a reduced number of echoes to the amplification circuit 26. The amplification circuit 26 receives the second voice signal without echoes, amplifies the second voice signal, and outputs an amplified second voice signal to the second switch circuit 27. The second switch circuit 27 receives the amplified second voice signal, and the second switch circuit 27 selectively outputs the amplified second voice signal to the speaker 22 or to the external speaker. The electronic accessory 100 and the electronic device 200 may both be always disposed within reach of the user, such as on a seat in a car, when the user is making a call when driving. In this way, the electronic accessory 100 greatly assists the electronic device 200 in allowing a user to use the device 200 entirely hands-free. When the user is driving, the in-car telephone loudspeaker may be utilized as the external speaker.

When the electronic device 200 acts as a media player, the first switch circuit 25 transmits the third voice signal from the electronic device 200 to the amplification circuit 26. The amplification circuit 26 receives the third voice signal, amplifies the third voice signal, and outputs the amplified third voice signal to the second switch circuit 27. The second switch circuit 27 receives the amplified third voice signal, and selectively outputs the amplified third voice signal to the speaker 22, or to the external speaker 400.

When the electronic accessory 100 acts as a radio receiver, the first switch circuit 25 receives the fourth voice signal from the FM receiver 21, and outputs the fourth voice signal to the amplification circuit 26. The amplification circuit 26 receives the fourth voice signal, amplifies the fourth voice signal, and outputs the amplified fourth voice signal to the second switch circuit 27. The second switch circuit 27 receives the amplified fourth voice signal, and outputs the amplified fourth voice signal to the speaker 22, or to the external speaker.

The first switch circuit 25 may preferentially output the first or second voice signals, and switch off an output of the third or fourth voice signals, when the first and/or second, or the third and/or fourth voice signals are simultaneously received. Further, the first switch circuit 25 switches on the output of the third or fourth voice signals, when the third and/or fourth voice signals are received without the first and/or second voice signals. The second switch circuit 27 may switch on or off an output of the first, second, third and/or fourth voice signals based on user input of pause. The user input may be via a keyboard or a touch panel which may be disposed on the electronic accessory 100, for example.

Referring to FIG. 1 again, the electronic device 200 includes an interface connector 206, an authentication IC 207 and an arithmetic unit 209. The interface connector 206 is connected to the authentication IC 207 and the arithmetic unit 209. The interface connector 206 is detachably connected to the interface connector 14 of the electronic accessory 100 for data transmission and exchange. The authentication IC 207 receives the authentication information from the authentication IC 10 of the electronic accessory 100, confirms whether the received authentication information is correct, and outputs a matched signal to the controller 11 when the received authentication information is correct. The arithmetic unit 209 receives the decoded satellite signals from the signal processing unit 12 via the interface connector 14 and 206, and calculates the position of the electronic device 200 according to the decoded satellite signals.

The working principles of the electronic accessory 100 in assisting the electronic device 200 to perform the positional and navigational functions is as follows.

The interface connector 14 is connected to the interface connector 206 of the electronic device 200. In response to user-startup of the controller 11, the controller 11 outputs a first control signal to the authentication IC 10. The authentication IC 10 receives the first control signal, and outputs the authentication information to the authentication IC 207 of the electronic device 200 based on the first control signal. The authentication IC 207 receives the authentication information from the authentication IC 10, and confirms whether the authentication information is correct. If the authentication information is correct, the electronic accessory 100 matches the electronic device 200. The electronic device 200 outputs the matched signal to the controller 11. If the authentication information is not correct, the electronic accessory 100 does not generate a matched signal, and no matched signal is output to the controller 11.

The controller 11 receives the matched signal, and outputs a second control signal to the signal processing unit 12 based on the matched signal. When the signal processing unit 12 receives the second control signal, the antennas 120 starts to search and receive satellite signals, and outputs the satellite signals received to the processing circuit 122. The processing circuit 122 receives the satellite signals, decodes the received satellite signals, and outputs the decoded satellite signals to the arithmetic unit 209 of the electronic device 200. The arithmetic unit 209 receives the decoded satellite signals, and establishes the precise location of the electronic device 200. In addition, when the antennas 120 are searching for satellite signals, the signal processing unit 12 can control the LED 131 of the indication circuit 13 to emit light intermittently. When the antennas 120 have completed search for satellite signals, the signal processing unit 12 can control the LED 131 to emit light continuously.

As described, since the electronic accessory 100 includes the audio processing circuit 20 can remove echoes and amplify the first and second voice signals. Both of the electronic accessory 100 and the electronic device 200 may be disposed on other hardware when the electronic device 200 itself is being used as a telephone in the hand(s) of the user. Therefore, the electronic accessory 100 is further able to assist the electronic device 200 in performing a hands-free function.

Furthermore, since the electronic accessory 100 further includes the signal processing unit 12 for providing the decoded satellite signals to the electronic device 200, the (expensive) services of a communication network are not required when the electronic device 200 is performing its positional and navigational functions. Accordingly, it becomes cheaper for the user to use the electronic device 200.

Moreover, since the electronic accessory 100 further includes the first charging circuit 15 used as a battery charger and the FM receiver 21 used as a radio receiver, the electronic accessory 100 is one single component capable of assisting the electronic device in a multitude of ways, to perform a plurality of functions. Accordingly, the single electronic accessory 100 is very convenient for a user.

The authentication IC 10 of electronic accessory 100 may be omitted if the electronic device 200 in other embodiments.

It is believed that the present embodiments and their advantages will be understood from the foregoing description, and it will be apparent that various changes may be made thereto without departing from the spirit and scope of the embodiments or sacrificing all of their material advantages.

What is claimed is:

1. An electronic accessory for an electronic device, comprising:
an audio processing circuit, comprising:
a first switch circuit;
a microphone configured to receive a first voice signal from a user in a call;
an echo cancellation circuit connected between the microphone and the first switch circuit and configured to remove echoes from the first voice signal, and output the first voice signal without echoes to the electronic device via the first switch circuit, the echo cancellation circuit further configured to receive a second voice signal from a caller transmitted by the electronic device via the first switch circuit, and remove echoes from the second voice signal; and
an amplification circuit connected to the first switch circuit via the echo cancellation circuit, and further directly connected to the first switch circuit, the amplification circuit configured to receive the second voice signal from the echo cancellation circuit, and amplify the second voice signal;
wherein the first switch circuit further receives a third voice signal from the multimedia content stored in the electronic device, and outputs the third voice signal to the amplification circuit directly, the amplification circuit further amplifies the received third voice signal, the first switch circuit preferentially outputs the first or second voice signals, and switches off an output of the third voice signal, when the first and/or second, and the third voice signals are simultaneously received, and the first switch circuit switches on the output of the third voice signal, when the third voice signal is received without the first and/or second voice signals.

2. The electronic accessory of claim 1, further comprising a frequency modulation receiver, wherein the frequency modulation receiver receives a fourth voice signal emitted by a frequency modulation emitter at a certain frequency, and outputs the fourth voice signal to the audio processing circuit.

3. The electronic accessory of claim 2, wherein the frequency modulation receiver further converts the fourth voice signal into a corresponding analog signal after the fourth voice signal is received from the frequency modulation emitter, and outputs the converted fourth voice signal to the audio processing circuit.

4. The electronic accessory of claim 2, wherein the first switch circuit further receives the fourth voice signal from the frequency modulation receiver, and outputs the fourth voice signal to the amplification circuit, the amplification circuit further amplifies the fourth voice signal.

5. The electronic accessory of claim 4, wherein the amplification circuit receives the fourth voice signal from the first switch circuit directly.

6. The electronic accessory of claim 4, wherein the first switch circuit preferentially outputs the first or second voice signals, and switches off an output of the fourth voice signal, when the first and/or second, and the fourth voice signals are simultaneously received, further, the first switch circuit switches on the output of the fourth voice signal, when the fourth voice signal is received without the first and/or second voice signals

7. The electronic accessory of claim 1, further comprising a signal processing unit, wherein the signal processing unit comprises antennas and a processing circuit, the antennas search and receive satellite signals, and output the received satellite signals to the processing circuit, the processing circuit receives the satellite signals from the antennas, and decodes the satellite signals to provide the decoded satellite signals to the electronic device to assist the operation of the positional and navigational functions.

8. The electronic accessory of claim 1, further comprising a first charging circuit, wherein the first charging circuit converts power from an external power supply, and outputs the converted power to charge the electronic device.

9. An electronic accessory for an electronic device, comprising:
an audio processing circuit, comprising:
a first switch circuit;
a microphone configured to receive a first voice signal from a user in a call;
an echo cancellation circuit connected between the microphone and the first switch circuit and configured to remove echoes from the first voice signal, and output the first voice signal without echoes to the electronic device via the first switch circuit, the echo cancellation circuit further configured to receive a second voice signal from a caller transmitted by the electronic device via the first switch circuit, and remove echoes from the second voice signal; and
an amplification circuit connected to the first switch circuit via the echo cancellation circuit, and further directly connected to the first switch circuit; and
a frequency modulation receiver configured to receive a third voice signal emitted by a frequency modulation emitter at a certain frequency, and outputs the third voice signal to the audio processing circuit;
wherein the first switch circuit further receives the third voice signal from the frequency modulation receiver, and outputs the third voice signal to the amplification circuit directly, the amplification circuit further amplifies the received third voice signal, the first switch circuit preferentially outputs the first or second voice signals, and switches off an output of the fourth voice signal, when the first and/or second, and the fourth voice signals are simultaneously received, and the first switch circuit switches on the output of the third voice signal, when the third voice signal is received without the first and/or second voice signals.

10. The electronic accessory of claim 9, wherein the frequency modulation receiver further converts the third voice signal into a corresponding analog signal after the third voice signal is received from the frequency modulation emitter, and outputs the converted third voice signal to the first switch circuit, the first switch circuit further receives the converted third voice signal from the frequency modulation receiver, and outputs the third voice signal to the amplification circuit.

11. The electronic accessory of claim 9, wherein the first switch circuit further receives a fourth voice signal from multimedia content stored in the electronic device, and outputs the fourth voice signal to the amplification circuit, the amplification circuit further amplifies the received fourth voice signal.

12. The electronic accessory of claim 11, wherein the first switch circuit preferentially outputs the first or second voice signals, and switches off an output of the fourth voice signal, when the first and/or second, and the fourth voice signals are simultaneously received, further, the first switch circuit switches on the output of the fourth voice signal, when the fourth voice signal is received without the first and/or second voice signals

13. The electronic accessory of claim 11, wherein the amplification circuit receives the fourth voice signal from the first switch circuit directly.

14. The electronic accessory of claim 9, further comprising a signal processing unit, wherein the signal processing unit comprises antennas and a processing circuit, the antennas search and receive satellite signals, and output the received satellite signals to the processing circuit, the processing circuit receives the satellite signals from the antennas, and decodes the satellite signals to provide the decoded satellite signals to the electronic device to assist the operation of the positional and navigational functions.

15. The electronic accessory of claim 9, further comprising a first charging circuit, wherein the first charging circuit converts power from an external power supply, and outputs the converted power to charge the electronic device.
